(19) United States
(12) Patent Application Publication
(10) Pub. No.: US 2026/0282068 A1
(43) Pub. Date: Sep. 17, 2026

(54) INTRA USER EQUIPMENT PRIORITIZATION FOR DATA DELAY

(71) Applicant: Lenovo (United States) Inc., Morrisville, NC (US)

(72) Inventors: Joachim Löhr, Wiesbaden (DE); Shwetha Sreejith, Steinbach (DE)

(73) Assignee: Lenovo (United States) Inc., Morrisville, NC (US)

(21) Appl. No.: 19/079,076

(22) Filed: Mar. 13, 2025

(51) Int. Cl. H04W 72/56; H04W 72/1268

(52) U.S. Cl. CPC H04W 72/56; H04W 72/1268

(57) ABSTRACT

Various aspects of the present disclosure relate to intra user equipment (UE) prioritization for data delay. A UE may receive uplink resource assignments, where each uplink resource assignment schedules an uplink transmission of a medium access control (MAC) protocol data unit (PDU). The UE may determine a priority of the uplink resource assignments for uplink resources that overlap in time based on a logical channel prioritization (LCP) that uses priorities of logical channels that have data to be multiplexed in a corresponding MAC PDU. A network equipment (NE) may determine the uplink resource assignments. The NE may transmit, to the UE, the uplink resource assignments and an indication of intra-UE prioritization of the uplink resource assignments for the uplink resources that overlap in time.

### TECHNICAL FIELD

The present disclosure relates to wireless communications, and more specifically to user equipment (UE) prioritization of data.

### BACKGROUND

A wireless communications system may include one or multiple network communication devices, which may be otherwise known as network equipment (NE), supporting wireless communications for one or multiple user communication devices, which may be otherwise known as UE, or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive uplink resource assignments, where each uplink resource assignment schedules an uplink transmission of a medium access control (MAC) protocol data unit (PDU); and determine a priority of the uplink resource assignments for uplink resources that overlap in time based on a logical channel prioritization (LCP) that uses priorities of logical channels that have data to be multiplexed in a corresponding MAC PDU.

A processor (e.g., a standalone processor chipset, or a component of a UE) for wireless communication is described. The processor may be configured to, capable of, or operable to perform one or more operations as described herein. For example, the processor may be configured to, capable of, or operable to receive uplink resource assignments, where each uplink resource assignment schedules an uplink transmission of a MAC PDU; and determine a priority of the uplink resource assignments for uplink resources that overlap in time based on an LCP that uses priorities of logical channels that have data to be multiplexed in a corresponding MAC PDU.

A method performed or performable by a UE for wireless communication is described. The method may include receiving uplink resource assignments, where each uplink resource assignment schedules an uplink transmission of a MAC PDU; and determining a priority of the uplink resource assignments for uplink resources that overlap in time based on an LCP that uses priorities of logical channels that have data to be multiplexed in a corresponding MAC PDU.

In some implementations of the UE, the processor, and the method described herein, the UE, the processor, and the method may be configured to, capable of, or operable to determine the priority of an uplink resource assignment based on at least one of a first prioritization part of the LCP or a second prioritization part of the LCP. In some implementations of the UE, the processor, and the method described herein, the UE, the processor, and the method may be configured to, capable of, or operable to receive a configuration of a first priority and a second priority for a logical channel (LCH); and determine a priority of the LCH for the first prioritization part of the LCP and the second prioritization part of the LCP based on the configuration. In some implementations of the UE, the processor, and the method described herein, the priority of the uplink resource assignment is based on the priorities of the LCHs used for the first prioritization part of the LCP. In some implementations of the UE, the processor, and the method described herein, the priority of the uplink resource assignment is determined based on a first priority that is configured for a LCH.

In some implementations of the UE, the processor, and the method described herein, the UE, the processor, and the method may be configured to, capable of, or operable to determine a priority of an uplink grant for a retransmission based on a highest priority of a LCH as determined based on the first prioritization part of the LCP or the second prioritization part of the LCP. In some implementations of the UE, the processor, and the method described herein, the UE, the processor, and the method may be configured to, capable of, or operable to determine a priority of an uplink grant for a retransmission based on a first priority configured for a LCH. In some implementations of the UE, the processor, and the method described herein, the UE, the processor, and the method may be configured to, capable of, or operable to determine a priority of an uplink grant in conjunction with a determination of the priorities of the logical channels based on at least one of a first prioritization part of the LCP or a second prioritization part of the LCP.

In some implementations of the UE, the processor, and the method described herein, the UE, the processor, and the method may be configured to, capable of, or operable to determine the priority of the uplink grant based on the first prioritization part of the LCP for generation of the MAC PDU. In some implementations of the UE, the processor, and the method described herein, the UE, the processor, and the method may be configured to, capable of, or operable to determine a priority of a hybrid automatic repeat request (HARQ) process based on a priority of a LCH used for a first prioritization part of the LCP or a second prioritization part of the LCP. In some implementations of the UE, the processor, and the method described herein, the UE, the processor, and the method may be configured to, capable of, or operable to determine a priority of a scheduling request (SR) based on a priority of a LCH corresponding to the SR.

An NE (e.g., a base station) for wireless communication is described. The NE may be configured to, capable of, or operable to perform one or more operations as described herein. For example, the NE may be configured to, capable of, or operable to determine uplink resource assignments, where each uplink resource assignment schedules an uplink transmission of a MAC PDU at a UE; and transmit, to the UE, the uplink resource assignments and an indication of intra-UE prioritization of the uplink resource assignments for uplink resources that overlap in time, the intra-UE prioritization based on an LCP that uses priorities of logical channels that have data to be multiplexed in a corresponding MAC PDU at the UE.

A processor (e.g., a standalone processor chipset, or a component of a NE) for wireless communication is described. The processor may be configured to, capable of, or operable to perform one or more operations as described herein. For example, the processor may be configured to, capable of, or operable to determine uplink resource assignments, where each uplink resource assignment schedules an uplink transmission of a MAC PDU at a UE; and transmit, to the UE, the uplink resource assignments and an indication of intra-UE prioritization of the uplink resource assignments for uplink resources that overlap in time, the intra-UE prioritization based on an LCP that uses priorities of logical channels that have data to be multiplexed in a corresponding MAC PDU at the UE.

A method performed or performable by an NE (e.g., a base station) for wireless communication is described. The method may include determining uplink resource assignments, where each uplink resource assignment schedules an uplink transmission of a MAC PDU at a UE; and transmitting, to the UE, the uplink resource assignments and an indication of intra-UE prioritization of the uplink resource assignments for uplink resources that overlap in time, the intra-UE prioritization based on an LCP that uses priorities of logical channels that have data to be multiplexed in a corresponding MAC PDU at the UE.

### BRIEF DESCRIPTION OF THE DRAWINGS

FIG. 1 illustrates an example of a wireless communications system in accordance with aspects of the present disclosure.

FIG. 2 illustrates an example of a UE in accordance with aspects of the present disclosure.

FIG. 3 illustrates an example of a processor in accordance with aspects of the present disclosure.

FIG. 4 illustrates an example of a NE in accordance with aspects of the present disclosure.

FIG. 5 illustrates a flowchart of a method performed by a UE in accordance with aspects of the present disclosure.

FIG. 6 illustrates a flowchart of a method performed by a NE in accordance with aspects of the present disclosure.

### DETAILED DESCRIPTION

In a wireless communications system, LCP is implemented to ensure that data from higher-priority LCHs is transmitted before data from lower-priority LCHs. This is implemented to help maintain the quality of service (QOS) for different types of traffic. In the LCP procedure, transmission resources are allocated to logical channels in order of their priority values. Once the higher-priority channels are served, remaining resources are allocated to other channels. This prioritization facilitates efficiently managing network resources so that critical data is transmitted in a timely manner.

The current LCP procedure has two stages, where in a first round of LCP, a UE allocates uplink resources based on a logical channel priority order. If any uplink (UL) resources remain after the first round, the UE allocates the remaining resources in a decreasing priority order during the second round of LCP. In order to provide a more equitable allocation, the MAC may further determine the priority of a LCH before executing the second round of the LCP procedure (i.e., assigning UL resources in a strict priority order). This may result in a LCH not being further prioritized (e.g., using the second, higher LCH priority) during the second round of the LCP procedure if all of the delay-critical data of a LCH has already been multiplexed in the MAC PDU during the first round of LCP. A consideration of whether to (re)determine the LCH priority before the second round of the LCP procedure may introduce some optional capability, which allows a UE to fall back to the default priority in the second round of LCP, such as when there is no delay-critical data left in the UE buffer for the corresponding LCH.

In scenarios for intra-UE prioritization, such as when multiple UL transmissions are overlapping (e.g., overlapping physical uplink shared channel (PUSCH) transmissions), a UE may prioritize the competing or colliding UL transmissions or UL grant, and only carries out the prioritized UL grant or transmission. The priority of an uplink grant may then be determined by the highest priority among priorities of the logical channels that are multiplexed (i.e., the MAC PDU to transmit is already stored in the HARQ buffer) or have data available that can be multiplexed (i.e., the MAC PDU to transmit is not stored in the HARQ buffer) in the MAC PDU, according to mapping restrictions.

With conventional LCP, it is uncertain as to which LCH priority a UE or MAC entity applies for an intra-UE prioritization scenario, given that a UE may use an additional (higher) LCH priority during the corresponding LCP procedure, in particular for situations when the UE is applying an additional priority only partially during the LCP procedure, such as for the first round of LCP. Accordingly, aspects of the described techniques in the present disclosure provide solutions for UE determinations of priority of an LCH, and for the UE determining a corresponding priority of an UL grant. Additionally, aspects of the present disclosure are related to UE behavior for a HARQ process selection and/or prioritization in conjunction with an enhanced LCP procedure.

As described for conventional LCP, a UE would not use the additional priority configured for a LCH to determine the priority of a corresponding UL grant, which may lead to a situation where the UE deprioritizes delay-critical data over non-delay critical data. The described solutions in the present disclosure may ensure that UL grants scheduling resources for delay-critical data are prioritized during intra-UE prioritization, without increasing UE implementation complexity.

In aspects of the described techniques, a UE may use the logical channel priorities used during the first round of the LCP procedure, which generated a MAC protocol data unit (PDU) (packaged as a transport block (TB)) for determining the priority of a corresponding UL grant. For intra-UE prioritization, to resolve colliding or overlapping UL grants, or PUSCH durations (or in general overlapping or colliding UL transmissions in physical uplink control channel (PUCCH) or PUSCH)), the UE may use the priority of a LCH which was used for the first round of the LCP procedure, which generated the MAC PDU without considering that the priority was used during second round of LCP.

Additional aspects include a UE may use the logical channel priorities which will be used during the complete LCP procedure for generating a MAC PDU for determining the priority of a corresponding UL grant. For intra-UE prioritization, the UE may use the default (first) priority of a LCH for determining the priority of a corresponding UL grant if the UE uses the default priority during the first round and/or the second round of LCP. For a scenario where a UE uses the additional priority for a LCH during both the first round and the second round of the LCP procedure, the UE may also use the additional priority of a LCH for determining the priority of the corresponding UL grant.

Additional aspects include a UE or MAC entity may prioritize the HARQ process identifier (ID) with the highest priority for a scenario when HARQ processes are colliding. The UE or MAC entity may also consider an additional priority of an LCH when determining the priority of a HARQ process (e.g., the priority of a HARQ process is determined by the highest priority among priorities of the logical channels that are multiplexed (i.e., the MAC PDU to transmit is already stored in the HARQ buffer) or have data available that can be multiplexed (i.e., the MAC PDU to transmit is not stored in the HARQ buffer) in the MAC PDU.

Aspects of the present disclosure are described in the context of a wireless communications system. In the wireless communications system, a UE and an NE (e.g., a base station, gNB, network entity, network node) may support wireless communication, including reception and/or transmission of wireless communication using time-frequency resources. For example, the UE and the NE may support communicating signals (e.g., carrying control information, data, or the like). It should be understood that various terms may be used interchangeably with “communicating,” such as “signaling,” “transmitting,” “receiving,” “outputting,” “forwarding,” “relaying,” “retrieving,” “obtaining,” and so forth.

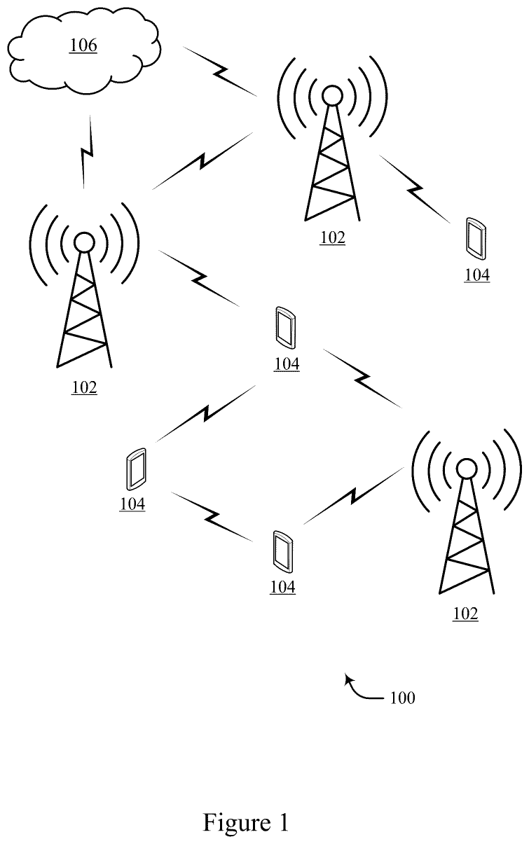

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, network infrastructure (or infrastructure), a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IOT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., p=0, u=1, u=2, p=3, u=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., u=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHZ), FR2 (24.25 GHz-52.6 GHZ), FR3 (7.125 GHz-24.25 GHZ), FR4 (52.6 GHz-114.25 GHZ), FR4a or FR4-1 (52.6 GHz-71 GHz), and FR5 (114.25 GHz-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FRI may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., p=2), which includes 60 kHz subcarrier spacing; and a fourth numerology (e.g., p=3), which includes 120 kHz subcarrier spacing.

A wireless communications systems may support LCP, which is implemented to ensure that data from higher-priority LCHs is transmitted before data from lower-priority LCHs. This is implemented to help maintain the quality of service (QOS) for different types of traffic. In the LCP procedure, transmission resources are allocated to logical channels in order of their priority values. Once the higher-priority channels are served, remaining resources are allocated to other channels.

This prioritization facilitates efficiently managing network resources so that critical data is transmitted in a timely manner.

With conventional LCP, it is uncertain as to which LCH priority a UE 104 or MAC entity applies for an intra-UE prioritization scenario, given that the UE 104 may use an additional (higher) LCH priority during the corresponding LCP procedure, in particular for situations when the UE is applying an additional priority only partially during the LCP procedure, such as for the first round of LCP. Accordingly, aspects of the described techniques in the present disclosure provide solutions for UE determinations of priority of an LCH, and for the UE 104 determining a corresponding priority of an UL grant. For conventional LCP, a UE 104 would not use the additional priority configured for a LCH to determine the priority of a corresponding UL grant, which may lead to a situation where the UE deprioritizes delay-critical data over non-delay critical data. The described solutions in the present disclosure may ensure that UL grants scheduling resources for delay-critical data are prioritized during intra-UE prioritization.

For example, an NE 102 and a UE 104 in the wireless communications system 100 may support aspects of the techniques described for intra-UE prioritization for data delay. According to implementations, one or more of the NEs 102 and the UEs 104 are operable to implement various aspects of the techniques described with reference to the present disclosure. For example, a UE 104 receives uplink resource assignments, where each uplink resource assignment schedules an uplink transmission of a MAC PDU. The UE 104 determines a priority of the uplink resource assignments for uplink resources that overlap in time based on a LCP that uses priorities of logical channels that have data to be multiplexed in a corresponding MAC PDU. An NE 102 (e.g., a base station, gNB, network entity, network node) determines uplink resource assignments, where each uplink resource assignment schedules an uplink transmission of a MAC PDU at a UE 104. The NE 102 transmits, to the UE, the uplink resource assignments and an indication of intra-UE prioritization of the uplink resource assignments for uplink resources that overlap in time, the intra-UE prioritization based on an LCP that uses priorities of logical channels that have data to be multiplexed in a corresponding MAC PDU at the UE.

In a wireless communications system, LCP is implemented to ensure that data from higher-priority LCHs is transmitted before data from lower-priority LCHs, but at the same time to avoid restricting or cutting off data transmission from the lower-priority LCHs. This is implemented to help maintain the quality of service (QOS) for different types of traffic. A value Bⱼ represents the number of bits that need to be prioritized for transmission from a specific logical channel j. If the value Bⱼ>0, it indicates that the LCH has not met its required (minimum/prioritized) bit rate. In the first round (also referred to herein as a part) of the LCP procedure, transmission resources are allocated to logical channels with Bⱼ>0 in order of their priority values. In the second round or part of the LCP procedure (e.g., once the minimum/prioritized bit rate requirements are fulfilled for the LCHs), remaining resources are allocated to the LCHs regardless of the value of Bⱼ. This prioritization facilitates efficiently managing network resources so that critical data is transmitted in a timely manner.

With reference to agreements on LCP enhancements, (1) only one additional priority is configured to an LCH for LCP enhancement; (2) an existing agreement, the remaining time threshold is configured per LCH; (3) there is no impact on buffer status report (BSR), scheduling request (SR), and dynamic scheduling request (DSR) triggering and reporting due to adjusted priority; (4) intra-UE prioritization shall also use the additional LCP priority for UL grant priority determination; (5) further study, intra-UE prioritization shall also use the additional LCP priority for SR priority determination; (6) no additional physical resource block (PRB) is needed for priority adjusted data; and further study to allow an LCH with an upgraded priority to be transmitted even if Bⱼ is negative (if configured by the network), while the remaining time is less the configured threshold.

Additional agreements on LCP enhancements include (1) as a baseline, the additional LCH priority is applied to both the first round and the second round of the LCP procedure, where the UE does not fall back to the default LCH priority in the second round even if there is no more LCH priority-adjusted data after the first round; and (2) as an optional capability, the UE can also support to fallback to default priority in the second round of LCP.

An option of overriding or adjusting the priority of a LCH during LCP based on the remaining time of the data of a LCH is used as a baseline for a delay-aware LCP procedure. A UE may use an additional (higher) LCH priority configured for a LCH if this LCH has delay-critical data available for transmissions. In a scenario, only one additional priority may be configured for an LCH as an LCP enhancement. The current LCP procedure has two rounds (or parts), where a UE allocates in the first round of LCP uplink resources based on Bⱼ in a logical channel priority order. If any UL resources remain after the first round, the UE allocates the remaining resources regardless of Bⱼ in a decreasing priority order during the second round of LCP. In order to provide a more equitable allocation, the MAC may further determine the priority of a LCH before executing the second round of the LCP procedure (i.e., assigning UL resources in a strict priority order regardless of Bⱼ). This may result in a LCH not being further prioritized (e.g., using the second, higher LCH priority) during the second round of the LCP procedure if all of the delay-critical data of a LCH has already been multiplexed in the MAC PDU during the first round of LCP. A consideration of whether to (re)determine the LCH priority before the second round of the LCP procedure may introduce some optional capability, which allows a UE to fall back to the default (first) priority in the second round of LCP, such as when there is no delay-critical data left in the UE buffer for the corresponding LCH.

For an intra-UE prioritization case when multiple UL transmissions are overlapping (e.g., overlapping PUSCH transmissions), a UE prioritizes the competing or colliding UL transmissions or UL grants, and only carries out the prioritized UL grant or transmission. The priority of an uplink grant is determined by the highest priority among priorities of the logical channels that are multiplexed (i.e., the MAC PDU to transmit is already stored in the HARQ buffer) or have data available that can be multiplexed (i.e., the MAC PDU to transmit is not stored in the HARQ buffer) in the MAC PDU, according to mapping restrictions.

With reference to intra-UE prioritization, and for configured UL grants configured with cg-RetransmissionTimer, the UE implementation selects a HARQ process ID among the HARQ process IDs available for the configured grant configuration. If the MAC entity is configured with intraCG-Prioritization, for HARQ process ID selection, the UE prioritizes the HARQ process ID with the highest priority. The priority of a HARQ process is determined by the highest priority among priorities of the LCHs that are multiplexed (i.e., the MAC PDU to transmit is already stored in the HARQ buffer) or have data available that can be multiplexed (i.e., the MAC PDU to transmit is not stored in the HARQ buffer) in the MAC PDU, according to mapping restrictions. If the MAC entity is configured with intraCG-Prioritization, for HARQ process ID selection among initial transmission and retransmission with equal priority, the UE prioritizes retransmissions before initial transmissions. The priority of a HARQ process for which no data for logical channels is multiplexed, or can be multiplexed in the MAC PDU, is lower than the priority of a HARQ process for which data for any logical channels is multiplexed or can be multiplexed in the MAC PDU. If the MAC entity is not configured with intraCG-Prioritization, for HARQ process ID selection, the UE prioritizes retransmissions before initial transmissions. The UE toggles the new data indicator (NDI) in the configured grant (CG)-uplink control information (UCI) for new transmissions and does not toggle the NDI in the CG-UCI in retransmissions.

For a MAC entity configured with Ich-basedPrioritization, priority of an uplink grant is determined by the highest priority among priorities of the logical channels that are multiplexed (i.e., the MAC PDU to transmit is already stored in the HARQ buffer) or have data available that can be multiplexed (i.e., the MAC PDU to transmit is not stored in the HARQ buffer) in the MAC PDU, according to mapping restrictions. The priority of an uplink grant for which no data for logical channels is multiplexed, or can be multiplexed, in the MAC PDU is lower than either the priority of an uplink grant for which data for any logical channel is multiplexed or can be multiplexed in the MAC PDU, or the priority of the logical channel triggering an SR.

For a MAC entity configured with lch-basedPrioritization, if the corresponding PUSCH transmission of a configured uplink grant is canceled by cell radio network temporary identifier (CI-RNTI), or canceled by a high physical layer (PHY)-priority PUCCH transmission, then this configured uplink grant is considered as a de-prioritized uplink grant. If this de-prioritized uplink grant is configured with autonomousTx, the configured grant timer (i.e., configuredGrantTimer) for the corresponding HARQ process of this de-prioritized uplink grant shall be stopped if it is running. If this de-prioritized uplink grant is configured with autonomousTx, the cg-RetransmissionTimer for the corresponding HARQ process of this de-prioritized uplink grant shall be stopped if it is running. In a scenario, if the MAC entity is configured with lch-basedPrioritization, and if there is an overlapping PUSCH duration of at least two configured uplink grants whose priorities are equal, the prioritized uplink grant is determined by UE implementation. In another scenario, if the MAC entity is not configured with Ich-basedPrioritization, and if there is an overlapping PUSCH duration of at least two configured uplink grants, it is up to the UE implementation to choose one of the configured uplink grants. In another scenario, if the MAC entity is configured with Ich-basedPrioritization, the MAC entity does not take uplink control information (UCI) multiplexing into account when determining whether the PUSCH duration of an uplink grant overlaps with the PUCCH resource for an SR transmission.

With reference to frequency resource assignment (downlink (DL)/UL) in 5G NR, both UL and DL resource assignments support only one single modulation and coding scheme (MCS) assignment applicable to all assigned resource blocks. The MCS for downlink control information (DCI) formats is as follows: DCI Format 0_0 MCS (5 bits). DCI Format 0_1, transport block 1, MCS (5 bits), and transport block 2 (only present if maxRank or maxMIMO-Layers is larger than 4), MCS (5 bits). DCI Format 0_2 MCS (5 bits). DCI Format 0_3 is used for the scheduling of one PUSCH in one cell, or multiple PUSCHs in multiple cells with one PUSCH per cell, and MCS number of bits are determined by block number 1, block number 2, . . . , block number N_{cell}^{UL}. Each block corresponds to the modulation and coding scheme for a cell, and the blocks are placed according to an ascending order of a serving cell index, with block number 1 corresponding to the MCS for the cell with the smallest serving cell index, MCS each block (5 bits).

For DCI Format 1_0 MCS (5 bits). DCI Format 1_1, transport block 1, MCS (5 bits), and transport block 2 (only present if maxNrofCode WordsScheduledByDCI equals 2), MCS (5 bits). DCI Format 1_2 MCS (5 bits). DCI Format 1_3 is used for the scheduling of one physical downlink shared channel (PDSCH) in one cell, or multiple PDSCHs in multiple cells with one PDSCH per cell. For transport block 1, MCS is the number of bits determined by block number 1, block number 2, . . . , block number N_{cell}^{DL}. Each block corresponds to the MCS for a cell, and the blocks are placed according to an ascending order of a serving cell index, with block number 1 corresponding to the MCS for the cell with the smallest serving cell index, and each block (5 bits). For transport block 2, MCS is the number of bits determined by block number 1, block number 2, . . . , block number N_{cell}^{DL3}. DCI Format 4_0 MCS (5 bits). DCI Format 4_1 MCS (5 bits). DCI Format 4_2, for transport block 1, MCS (5 bits), and for transport block 2 (only present if maxNrofCode WordsScheduledByDCI equals 2), then MCS (5 bits). While DCI formats 0_3/1_3 are capable to signal a plurality of MCS fields, each MCS field is applicable to a whole cell, and therefore to a single TB (i.e., the same MCS is applied to a TB).

Aspects of the disclosure for intra-UE prioritization for data delay include implementations for retransmission, such as by a UE. In an implementation pertaining to retransmission, a UE may use the logical channel priorities used during the first round of the LCP procedure, which generated a MAC protocol data unit (PDU) (packaged as a TB) for determining the priority of a corresponding UL grant. For intra-UE prioritization, to resolve colliding or overlapping UL grants, or physical uplink shared channel (PUSCH) durations (or in general overlapping or colliding UL transmissions in PUCCH or PUSCH)), the UE may use the priority of a LCH which was used for the first round of the LCP procedure, which generated the MAC PDU without considering that the priority was used during second round of LCP.

In this implementation, an assumption is that a MAC PDU of a colliding or overlapping UL grant is already stored in the HARQ buffer (e.g., a PUSCH retransmission is overlapping or colliding with another UL transmission). If an additional or higher LCH priority was used for a LCH in the first round of the LCP procedure in order to prioritize delay-critical data pending for transmission (e.g., data for which the remaining time is below a configured threshold), then the UE shall use this additional LCH priority in order to determine the priority of the corresponding UL grant. Even if the “default” (e.g., not the additional or higher) LCH priority was used during the second round of LCP, the UE or MAC uses the additional or higher LCH priority to determine the priority of the corresponding UL grant. The UE or MAC determines the priority of the uplink grant as the highest LCH priority among the priorities of the logical channels that are multiplexed in the MAC PDU. Here the second (additional or higher) LCH priority is used for a LCH for the determination of the UL grant priority if the additional LCH priority was used during the first round of the LCP for a LCH that multiplexed data in the MAC PDU.

In another implementation pertaining to retransmission, a UE may use the default (first) priority of a LCH that is multiplexed in a MAC PDU to determine the priority of an UL grant if the UE has used the default priority during the second round of LCP. As an alternative to the implementation above and for intra-UE prioritization for colliding or overlapping UL grants or PUSCH durations (or in general overlapping or colliding UL transmissions (PUCCH/PUSCH)), a UE may use the default priority of a LCH if the default priority was used or applied for any of the first two rounds of LCP which generated the MAC PDU. For this implementation, an assumption is that a MAC PDU of a colliding or overlapping UL grant is already stored in the HARQ buffer (e.g., PUSCH retransmission is overlapping or colliding with another UL transmission). If the default (first) LCH priority was used for a LCH in either the first round or second round of the LCP procedure, the UE shall use this default LCH priority in order to determine the priority of the corresponding UL grant. Even if the additional or higher LCH priority was used during the LCP, the UE or MAC does not use the additional or higher LCH priority for determining the priority of the corresponding UL grant.

In another implementation pertaining to retransmission, a UE may always use the “default” priority of a LCH that is multiplexed in a MAC PDU to determine the priority of the corresponding UL grant, regardless of whether an additional or higher priority was used during the LCP procedure for a LCH that is multiplexed in the MAC PDU (e.g., to prioritize delay-critical data during LCP). According to an aspect of the implementation, and for intra-UE prioritization for colliding or overlapping UL grants or PUSCH durations (or in general overlapping or colliding UL transmissions (PUCCH/PUSCH)), a UE may use the default (first) priority which is configured for a LCH that is multiplexed in a MAC PDU to determine the priority of the corresponding UL grant.

For this implementation, an assumption is that a MAC PDU of a colliding or overlapping UL grant is already stored in the HARQ buffer (e.g., a PUSCH retransmission is overlapping or colliding with another UL transmission). Even if an additional or higher LCH priority was used for a LCH in the first round and/or second round of the LCP procedure in order to prioritize delay-critical data pending for transmission (e.g., data for which the remaining time is below a configured threshold), the UE shall always use the default (first) LCH priority in order to determine the priority of the corresponding UL grant. A UE or MAC determines the priority of the uplink grant as the highest LCH priority among the priorities of the logical channels that are multiplexed in the MAC PDU.

Here the default LCH priority is used for a LCH for the determination of the UL grant priority regardless of whether an additional or higher LCH priority was used during the LCP for a LCH that is multiplexed in the MAC PDU. According to this implementation, additional LCH priorities are not considered for determining the priority of an UL grant for overlapping UL transmissions for an intra-UE prioritization.

Aspects of the disclosure include implementation of retransmissions, such as by an NE. In an implementation pertaining to retransmission and intra-UE prioritization, a network entity (NE, network node) may configure a UE with rules for determining the priority of an UL grant for intra-UE prioritization for colliding or overlapping UL grants or PUSCH durations (or in general overlapping or colliding UL transmissions (PUCCH/PUSCH)). In an implementation, the network may configure whether a UE shall use the priority of a LCH used during the first round of LCP or the second round of LCP for determining the priority of the corresponding UL grant.

Aspects of the disclosure include implementations for initial transmission, such as by a UE. In an implementation pertaining to initial transmission and for intra-UE prioritization, a UE may determine the priority of an UL grant during the LCP procedure performed for the UL grant.

According to an aspect of the implementation, a UE or MAC may determine the priority of an UL grant when it determines the LCH priorities used during the LCP procedure, such as when the UE or MAC determines whether an additional priority is used for a LCH that is eligible for the LCP according to multiplexing restrictions (e.g., during an initial round of the LCP procedure, in order to prioritize delay-critical data during LCP).

In another implementation pertaining to initial transmission, a UE may use the logical channel priorities which will be used during the first round of the LCP procedure, which generates a MAC PDU for determining the priority of a corresponding UL grant. For intra-UE prioritization, to resolve colliding or overlapping UL grants, or PUSCH durations (or in general overlapping or colliding UL transmissions in PUCCH or PUSCH), the UE may use the priority of a LCH which will be used for the first round of the LCP procedure to determine the priority of a corresponding UL grant. For this implementation, an assumption is that a MAC PDU of a colliding or overlapping UL grant to transmit is not stored in the HARQ buffer (initial transmission case). A UE or MAC determines the priority of an UL grant based on the priorities of the LCHs that have data available for transmission that can be multiplexed in the corresponding MAC PDU considering the configured LCH restrictions.

If an additional or higher LCH priority will be used for a LCH in the first round of the LCP procedure in order to prioritize delay-critical data pending for transmission (e.g., data for which the remaining time is below a configured threshold), the UE shall use this additional LCH priority in order to determine the priority of the corresponding UL grant. Even if the “default” (not the additional or higher) LCH priority would be used during the second round of LCP, the UE or MAC uses the additional or higher LCH priority to determine the priority of the corresponding UL grant. The UE can determine whether the remaining time of data of a LCH which is eligible for an UL grant is below a configured threshold to decide whether to apply an additional or higher priority for a LCH during the first round of LCP. A UE or MAC may use additional priorities selected in this step (e.g., when determining the remaining time of data of a LCH) to determine the priority of the corresponding UL grant.

In another implementation pertaining to initial transmission, a UE may use the logical channel priorities which will be used during the complete LCP procedure for generating a MAC PDU for determination of the priority of the corresponding UL grant. According to an aspect of the implementation and for intra-UE prioritization (e.g., if there are colliding or overlapping UL grants or PUSCH durations or in general overlapping or colliding UL transmissions (PUCCH/PUSCH)), the UE may use the default (first) priority of a LCH to determine the priority of the corresponding UL grant if the UE will use the default priority during the first round and/or second round of LCP. Only for cases when a UE will use the additional priority for a LCH during both the first round and the second round of LCP procedure, the UE will also use the additional priority of a LCH to determine the priority of the corresponding UL grant.

For this implementation, an assumption is that a MAC PDU of a colliding or overlapping UL grant to transmit is not stored in the HARQ buffer (initial transmission case). A UE or MAC can determine the priority of an UL grant based on the priorities of the LCHs that have data available for transmission that can be multiplexed in the corresponding MAC PDU considering the configured LCH restrictions. If an additional or higher LCH priority will be used for a LCH in the first round and second round of the LCP procedure, in order to prioritize delay-critical data pending for transmission (e.g., data for which the remaining time is below a configured threshold), the UE shall use this additional LCH priority in order to determine the priority of the corresponding UL grant. The UE can determine whether the remaining time of data of a LCH which is eligible for an UL grant is below a configured threshold to determine whether to apply an additional or higher priority for a LCH during the complete LCP procedure. The UE may determine (e.g., based on an amount of data pending for transmission), whether a UE or MAC will use the additional priority also during the second round of LCP. A UE or MAC uses the additional priorities selected in this implementation to determine the priority of a corresponding UL grant if an additional priority will be used during a complete LCP procedure. Otherwise, if an additional priority is only used for the first round of LCP, but not for the second round, then the default priority is used to determine the priority of the corresponding UL grant.

In another implementation pertaining to initial transmission, a UE may consider an UL grant as a de-prioritized grant, such as in the case of a collision (overlapping UL transmission), when the corresponding MAC PDU contains only data for which the corresponding packet data convergence protocol (PDCP) discard timer is already expired. According to an implementation, the priority of an uplink grant for which only outdated (discardTimer is expired) data of logical channels is multiplexed or can be multiplexed in the MAC PDU is lower than the priority of an uplink grant which carries data for which the PDCP discardTimer is not expired. Since data for which the discardTimer is already expired may not be useful from an application perspective, the UE can down-prioritize such outdated data during intra-UE prioritization.

Aspects of the disclosure include implementation of initial transmission, such as by a NE. In an implementation pertaining to initial transmission and intra-UE prioritization, a network entity (NE, network node) may configure a UE with rules for determining the priority of an UL grant for intra-UE prioritization for colliding or overlapping UL grants or PUSCH durations (or in general overlapping or colliding UL transmissions (PUCCH/PUSCH)). In an implementation, the network may configure whether a UE shall use the priority of a LCH that will be used during the first round of LCP or the second round of LCP for determining the priority of the corresponding UL grant.

Additional aspects of the disclosure considers HARQ process selection, such as by a UE. In an implementation, a UE or MAC entity may prioritize the HARQ process ID with the highest priority for a scenario when HARQ processes are colliding. The UE or MAC entity may also consider an additional priority of an LCH when determining the priority of a HARQ process (e.g., the priority of a HARQ process is determined by the highest priority among priorities of the logical channels that are multiplexed (i.e., the MAC PDU to transmit is already stored in the HARQ buffer) or have data available that can be multiplexed (i.e., the MAC PDU to transmit is not stored in the HARQ buffer) in the MAC PDU. In an implementation, a UE or MAC entity may apply the same behavior as outlined in the above implementations (pertaining to initial transmissions and retransmissions) for determining the priority of an UL grant for deciding the priority of an HARQ process. In an implementation a UE may use the logical channel priorities which will be used during the first round of the LCP procedure, which generates a MAC PDU for a HARQ process for determining the priority of a corresponding HARQ process. In another implementation, a UE may use an additional (higher) LCH priority in order to determine the priority of a HARQ process if an additional or higher LCH priority was used for a LCH in the first round of the LCP procedure to generate a MAC PDU for the corresponding HARQ process.

Aspects of the disclosure include implementation of HARQ process selection, such as by a NE. In an implementation pertaining to HARQ process selection and intra-UE prioritization, a network entity (NE, network node) may configure a UE with rules for determining the priority of a HARQ process for intra-UE prioritization. In an implementation, the network may configure whether a UE shall use the priority of a LCH that will be used or was used during the first round of LCP or the second round of LCP for determining the priority of the corresponding HARQ process.

Aspects of the disclosure considers a scheduling request (SR), such as by a UE. In an implementation, a MAC entity of a UE may determine the priority of a SR based on the priority of the LCH triggering the SR that the UE or MAC entity would apply for an LCP procedure being performed at the time of determining the priority of the SR. In an implementation, a MAC entity may determine the priority of the LCH that triggers a SR as the priority which the MAC would apply for this LCH during the first round of an LCP procedure being performed at the time when the MAC entity is determining the priority of the SR. For scenarios when the MAC would apply an additional (higher) priority for the LCH due to delay-critical data pending for transmission during the first round of the LCP procedure, the MAC may use this additional (higher) priority to determine the priority of an SR (e.g., for intra-UE prioritization to determine whether to prioritize the SR or some other overlapping or colliding UL transmission). According to an implementation, the MAC may use the additional priority of a LCH that is triggering a SR to determine the priority of the SR only if the MAC would apply the additional priority during the complete LCP procedure (e.g., the first round and the second round of LCP), otherwise the MAC would use the default priority of the LCH to determine the priority of an SR.

Additional aspects of the disclosure considers DSR, such as by a UE. In an implementation, a packet data convergence protocol (PDCP) service data units (SDUs)/PDCP data PDUs to be retransmitted for acknowledgement mode data radio bearers (AM DRBs) may be considered in the delay-reporting PDCP data volume according to their remaining time. In an implementation, a UE handles PDCP SDUs/PDCP data PDUs and/or RLC PDUs to be retransmitted from a delay reporting perspective the same as PDCP SDUs/PDUs and RLC PDUs/SDUs to be initially transmitted. In an example the PDCP SDUs/PDCP data PDUs and/or RLC PDUs to be retransmitted are reported in the delay-critical data volume associated with their remaining time.

In an example, a PDCP entity may consider PDCP SDUs/PDCP PDUs to be retransmitted for the delay reporting PDCP data volume calculation in the data volume according to their associated remaining time. The PDCP SDUs/PDCP PDUs to be retransmitted are handled the same as PDCP SDUs/PDCP PDUs stored in a PDCP buffer for initial transmission. The RLC PDUs to be retransmitted are reported in the RLC data volume associated with the shortest remaining time, or alternatively with the shortest reporting threshold included in the DSR. In an implementation PDCP control PDUs and/or RLC control PDUs are reported in the data volume associated with the shortest reporting threshold included in the DSR (e.g., reported as the most delay critical data with the shortest remaining time). Since PDCP/RLC control PDUs don't have an associated PDCP discardTimer, they may be considered as the data with the shortest remaining time reported in a DSR medium access control (MAC) control element (CE).

Aspects of the disclosure considers RLC Details for configuration of a new timer with t-Reassembly. A new RLC timer at the receiver (Rx) may be implemented to determine obsolete RLC SDUs. The timer starts when the gap is detected at the RLC layer. The abandoned RLC SDUs determined by a new RLC timer are positively acknowledged in the STATUS report. When the transmit (TX) RLC entity receives a discard indication of the SDU from a PDCP, the TX RLC entity considers the SDU as an outdated SDU. The TX RLC entity does not perform any transmission or retransmission of such SDU/SDU segment. A new RLC timer at the TX is not introduced to determine outdated RLC SDUs. The new RLC timer at the receiver (RX) is per RLC entity. The duration of the new RLC timer is not lower than that of t-reassembly.

The new timer at the RLC receiver may be configured per RLC entity the same as the t-Reassembly timer. The t-Reassembly timer and the new timer (e.g., t-Receive) are also started when a gap is detected at the RLC layer. Hence, these timers, when configured, will start at the same time for the same SDU. It is possible for the network to configure the duration of the t-Receive timer to be the same as the duration of the t-Reassembly timer (i.e., the two timers will also expire at the same time if configured for the same duration value). This can lead to some discrepancy in the status reporting at the RLC layer. When t-Reassembly expires at the RLC receiver, a status report is submitted to its peer entity (provided t-StatusProhibit is not running), where the status report negatively acknowledges (NACK) any SDU with a sequence number (SN) such that RX_Next<=SN<RX_Highest_Status, and that was not received either fully or partially (i.e., missing segments of the RLC PDU). Alternatively, when t-Receive expires at the RLC receiver, a status report is submitted to its peer entity, where the status report positively acknowledges (ACK/dummy ACK) any SDU with a sequence number (SN) such that RX_Next<=SN<RX_Highest_Status, and that was not received either fully or partially (i.e., missing segments of the RLC PDU). Here, RX_Next is the receive state variable that holds the value of the SN following the last in-sequence completely received RLC SDU, and RX_Highest Status is the maximum status transmit state variable that holds the highest possible value of the SN which can be indicated by “ACK_SN” when a STATUS PDU needs to be constructed. Additionally, the receiving window is also updated upon expiry of the t-Receive timer. That is, if the t-Reassembly and t-Receive are set to the same value and expire simultaneously, two status reports would be simultaneously triggered containing contradicting acknowledgements, leading to redundancy of the t-Reassembly timer as well as unnecessary retransmission(s) at the transmitter side of RLC.

With reference to RX, aspects of the disclosure include implementations for RX side behavior. In an implementation, the RLC receiver can cancel a first status report that is triggered but not yet submitted to lower layers as long as a second status report is triggered that contains a positive acknowledgment for one or more of the RLC SDUs (including segments of RLC SDUs) included in the first status report. That is, if two status reports are triggered for a same set of one or more RLC SDUs (including segments of RLC SDUs), the RLC receiver will only submit one status report to lower layers and the status report containing positive acknowledgments will take precedence. In an implementation, this may be limited to only the configuration where both t-Reassembly and t-Receive are simultaneously configured to a RLC entity with the same timer duration value.

An example text proposal for RX side behavior is provided as:
An AM RLC entity sends STATUS PDUs to its peer AM RLC entity in order to provide positive and/or negative acknowledgements of RLC SDUs (or portions of them). Triggers to initiate STATUS reporting include:
Polling from its peer AM RLC entity:
When an acknowledged mode (AMD) PDU with SN=x and the P field set to “1” is received from lower layer, the receiving side of an AM RLC entity shall:
if the AMD PDU is to be discarded as specified in clause 5.2.3.2.2; or
if x<RX_Highest_Status or x>=RX_Next+AM_Window_Size:
trigger a STATUS report. else:
delay triggering the STATUS report until x<RX_Highest_Status or x>=RX_Next+AM_Window_Size.
NOTE 1: This ensures that the RLC Status report is transmitted after HARQ reordering. Detection of reception failure of an AMD PDU. The receiving side of an AM RLC entity shall trigger a STATUS report when t-Reassembly expires.
NOTE 2: The expiry of t-Reassembly triggers both RX_Highest_Status to be updated and a STATUS report to be triggered, but the STATUS report shall be triggered after RX_Highest_Status is updated. Abandonment of an AMD PDU. The receiving side of an AM RLC entity shall trigger a STATUS report when t-Receive expires.
NOTE 3: If two status reports are triggered for a same set of one or more RLC SDUs (including segments of RLC SDUs), the RLC entity should only submit one status report to lower layers and the status report containing positive acknowledgments will take precedence.

According to another implementation, the RLC receiver, if configured with both t-Reassembly and t-Receive simultaneously with the same timer duration value, considers this as an implicit configuration to disable the t-Reassembly timer. That is, even when the conditions for starting t-Reassembly are satisfied, it will not be started provided the above criteria for implicit disabling is met. In another implementation, the RLC receiver, if configured with both t-Reassembly and t-Receive simultaneously with the same timer duration value, does not trigger a status report upon expiry of the t-Reassembly timer. That is, only one status report is triggered by the RLC receiver which is based on the expiry of the t-Receive timer (provided the above criteria of a same timer duration is met).

With reference to TX, aspects of the disclosure include implementations for TX side behavior. In an implementation, the RLC transmitter can cancel any retransmission that was triggered based on a first status report but not yet submitted to lower layers when a second status report is received containing positive acknowledgments for one or more of the RLC SDUs (including segments of RLC SDUs) that were negatively acknowledged in the first status report. In an implementation, this method may be limited to only the configuration when both t-Reassembly and t-Receive are simultaneously configured to a RLC entity with the same timer duration value. An example text proposal for TX side behavior is provided as:
When receiving a negative acknowledgement for an RLC SDU or an RLC SDU segment by a STATUS PDU from its peer AM RLC entity, the transmitting side of the AM RLC entity shall: if the SN of the corresponding RLC SDU falls within the range TX_Next_Ack<=SN<=the highest SN of the AMD PDU among the AMD PDUs submitted to lower layer, consider the RLC SDU or the RLC SDU segment for which a negative acknowledgement was received for retransmission.
NOTE: RLC transmitter cancels a retransmission that was triggered based on a first status report but not yet submitted to lower layers when a second status report is received containing positive acknowledgments for one or more of the RLC SDUs (including segments of RLC SDUs) that were negatively acknowledged in the first status report.

In another implementation, when an RLC entity is configured simultaneously with t-Receive and t-Reassembly timers with the same timer duration value, the RLC transmitter can ignore any status report that is received containing negative acknowledgements for one or more RLC SDUs (including segments of RLC SDUs). That is, the criteria of a same timer duration is considered as an implicit configuration on the RLC transmitter to only accept status reports containing positive acknowledgements, and any other status reports received (i.e., containing one or more negative acknowledgements) are ignored or discarded. In another implementation, the status report triggered by the expiry of t-Receive can be differentiated from the status report triggered by the expiry of t-Reassembly (i.e., legacy status report) by means of a new control PDU format or a bit indicator to represent the status report type. The RLC transmitter may then decide to read or ignore the status report based on its type. For example, if the status report was a legacy report and the criteria of a same timer duration is fulfilled, the RLC transmitter can ignore or discard any legacy status report received. The transmitting side of an AM RLC entity can receive a negative acknowledgement (notification of reception failure by its peer AM RLC entity) for an RLC SDU or an RLC SDU segment by the following: STATUS PDU from its peer AM RLC entity.

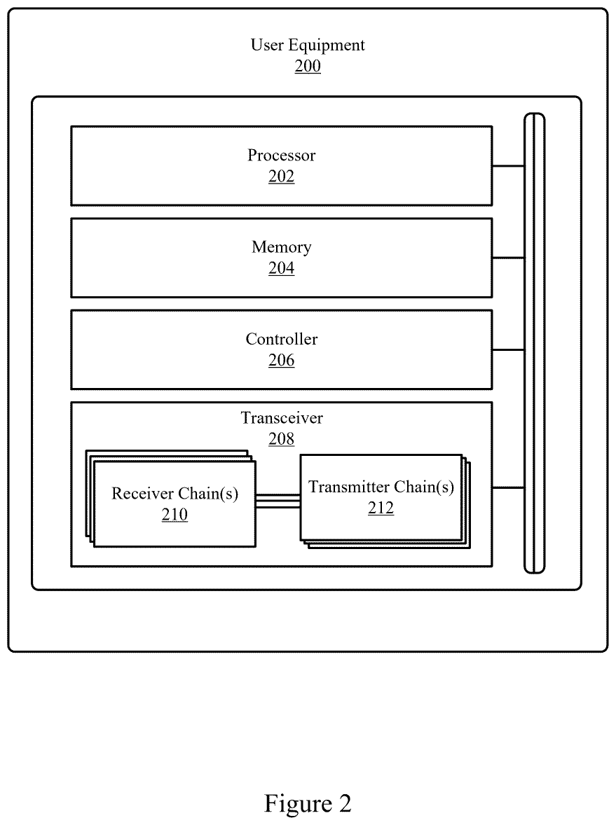

FIG. 2 illustrates an example of a UE 200 in accordance with aspects of the present disclosure. The UE 200 may include a processor 202, a memory 204, a controller 206, and a transceiver 208. The processor 202, the memory 204, the controller 206, or the transceiver 208, or various combinations thereof or various components thereof may be examples of means for performing various aspects of the present disclosure as described herein. These components may be coupled (e.g., operatively, communicatively, functionally, electronically, electrically) via one or more interfaces.

The processor 202, the memory 204, the controller 206, or the transceiver 208, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 202 may include an intelligent hardware device (e.g., a general-purpose processor, a DSP, a CPU, an ASIC, an FPGA, or any combination thereof). In some implementations, the processor 202 may be configured to operate the memory 204. In some other implementations, the memory 204 may be integrated into the processor 202. The processor 202 may be configured to execute computer-readable instructions stored in the memory 204 to cause the UE 200 to perform various functions of the present disclosure.

The memory 204 may include volatile or non-volatile memory. The memory 204 may store computer-readable, computer-executable code including instructions when executed by the processor 202 cause the UE 200 to perform various functions described herein. The code may be stored in a non-transitory computer-readable medium such as the memory 204 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 202 and the memory 204 coupled with the processor 202 may be configured to or operable to cause the UE 200 to perform one or more of the functions described herein (e.g., executing, by the processor 202, instructions stored in the memory 204). For example, the processor 202 may support wireless communication at the UE 200 in accordance with examples as disclosed herein. The UE 200 may be configured to or operable to support a means for receiving uplink resource assignments, where each uplink resource assignment schedules an uplink transmission of a MAC PDU; and determining a priority of the uplink resource assignments for uplink resources that overlap in time based on an LCP that uses priorities of logical channels that have data to be multiplexed in a corresponding MAC PDU.

Additionally, the UE 200 may be configured to or operable to support any one or combination of the method including determining the priority of an uplink resource assignment based on a first prioritization part of the LCP or a second prioritization part of the LCP. The method including receiving a configuration of a first priority and a second priority for a LCH, and determining a priority of the LCH for the first prioritization part of the LCP and the second prioritization part of the LCP based on the configuration. The priority of the uplink resource assignment is based on the priorities of the LCHs used for the first prioritization part of the LCP.

The priority of the uplink resource assignment is determined based on a first priority that is configured for a LCH. The method including determining a priority of an uplink grant for a retransmission based on a highest priority of a LCH as determined based on the first prioritization part of the LCP or the second prioritization part of the LCP. The method including determining a priority of an uplink grant for a retransmission based on a first priority configured for a LCH. The method including determining a priority of an uplink grant in conjunction with a determination of the priorities of the logical channels based on at least one of a first prioritization part of the LCP or a second prioritization part of the LCP. The method including determining the priority of the uplink grant based on the first prioritization part of the LCP for generation of the MAC PDU. The method including determining a priority of a HARQ process based on a priority of a LCH used for a first prioritization part of the LCP or a second prioritization part of the LCP. The method including determining a priority of a SR based on a priority of a LCH corresponding to the SR.

Additionally, or alternatively, the UE 200 may support at least one memory (e.g., the memory 204) and at least one processor (e.g., the processor 202) coupled with the at least one memory and configured to or operable to cause the UE to receive uplink resource assignments, where each uplink resource assignment schedules an uplink transmission of a MAC PDU; and determine a priority of the uplink resource assignments for uplink resources that overlap in time based on an LCP that uses priorities of logical channels that have data to be multiplexed in a corresponding MAC PDU.

Additionally, the UE 200 may be configured to or operable to support any one or combination of the at least one processor is operable to cause the UE to determine the priority of an uplink resource assignment based on at least one of a first prioritization part of the LCP or a second prioritization part of the LCP. The at least one processor is operable to cause the UE to receive a configuration of a first priority and a second priority for a LCH, and determine a priority of the LCH for the first prioritization part of the LCP and the second prioritization part of the LCP based on the configuration. The priority of the uplink resource assignment is based on the priorities of the LCHs used for the first prioritization part of the LCP. The priority of the uplink resource assignment is determined based on a first priority that is configured for a LCH. The at least one processor is operable to cause the UE to determine a priority of an uplink grant for a retransmission based on a highest priority of a LCH as determined based on the first prioritization part of the LCP or the second prioritization part of the LCP. The at least one processor is operable to cause the UE to determine a priority of an uplink grant for a retransmission based on a first priority configured for a LCH. The at least one processor is operable to cause the UE to determine a priority of an uplink grant in conjunction with a determination of the priorities of the logical channels based on at least one of a first prioritization part of the LCP or a second prioritization part of the LCP. The at least one processor is operable to cause the UE to determine the priority of the uplink grant based on the first prioritization part of the LCP for generation of the MAC PDU. The at least one processor is operable to cause the UE to determine a priority of a HARQ process based on a priority of a LCH used for a first prioritization part of the LCP or a second prioritization part of the LCP. The at least one processor is operable to cause the UE to determine a priority of a SR based on a priority of a LCH corresponding to the SR.

The controller 206 may manage input and output signals for the UE 200. The controller 206 may also manage peripherals not integrated into the UE 200. In some implementations, the controller 206 may utilize an operating system such as iOS®, ANDROID®, WINDOWS®, or other operating systems. In some implementations, the controller 206 may be implemented as part of the processor 202.

In some implementations, the UE 200 may include at least one transceiver 208. In some other implementations, the UE 200 may have more than one transceiver 208. The transceiver 208 may represent a wireless transceiver. The transceiver 208 may include one or more receiver chains 210, one or more transmitter chains 212, or a combination thereof.

A receiver chain 210 may be configured to receive signals (e.g., control information, data, packets) over a wireless medium. For example, the receiver chain 210 may include one or more antennas to receive a signal over the air or wireless medium. The receiver chain 210 may include at least one amplifier (e.g., a low-noise amplifier (LNA)) configured to amplify the received signal. The receiver chain 210 may include at least one demodulator configured to demodulate the receive signal and obtain the transmitted data by reversing the modulation technique applied during transmission of the signal. The receiver chain 210 may include at least one decoder for decoding the demodulated signal to receive the transmitted data.

A transmitter chain 212 may be configured to generate and transmit signals (e.g., control information, data, packets). The transmitter chain 212 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 212 may also include at least one power amplifier configured to amplify the modulated signal to an appropriate power level suitable for transmission over the wireless medium. The transmitter chain 212 may also include one or more antennas for transmitting the amplified signal into the air or wireless medium.

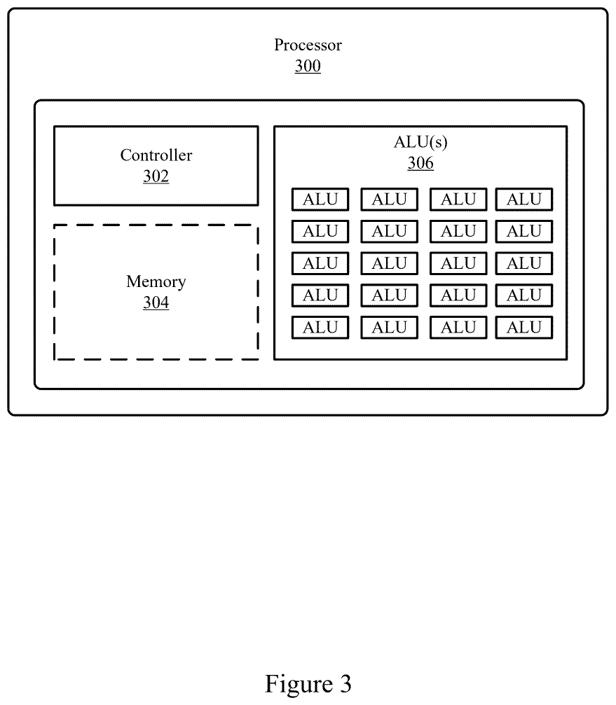

FIG. 3 illustrates an example of a processor 300 in accordance with aspects of the present disclosure. The processor 300 may be an example of a processor configured to perform various operations in accordance with examples as described herein. The processor 300 may include a controller 302 configured to perform various operations in accordance with examples as described herein. The processor 300 may optionally include at least one memory 304, which may be, for example, an L1/L2/L3 cache. Additionally, or alternatively, the processor 300 may optionally include one or more arithmetic-logic units (ALUs) 306. One or more of these components may be in electronic communication or otherwise coupled (e.g., operatively, communicatively, functionally, electronically, electrically) via one or more interfaces (e.g., buses).

The processor 300 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 300) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 302 may be configured to manage and coordinate various operations (e.g., signaling, receiving, obtaining, retrieving, transmitting, outputting, forwarding, storing, determining, identifying, accessing, writing, reading) of the processor 300 to cause the processor 300 to support various operations in accordance with examples as described herein. For example, the controller 302 may operate as a control unit of the processor 300, generating control signals that manage the operation of various components of the processor 300. These control signals include enabling or disabling functional units, selecting data paths, initiating memory access, and coordinating timing of operations.

The controller 302 may be configured to fetch (e.g., obtain, retrieve, receive) instructions from the memory 304 and determine subsequent instruction(s) to be executed to cause the processor 300 to support various operations in accordance with examples as described herein. The controller 302 may be configured to track memory addresses of instructions associated with the memory 304. The controller 302 may be configured to decode instructions to determine the operation to be performed and the operands involved. For example, the controller 302 may be configured to interpret the instruction and determine control signals to be output to other components of the processor 300 to cause the processor 300 to support various operations in accordance with examples as described herein. Additionally, or alternatively, the controller 302 may be configured to manage flow of data within the processor 300. The controller 302 may be configured to control transfer of data between registers, ALUs 306, and other functional units of the processor 300.

The memory 304 may include one or more caches (e.g., memory local to or included in the processor 300 or other memory, such as RAM, ROM, DRAM, SDRAM, SRAM, MRAM, flash memory, etc. In some implementations, the memory 304 may reside within or on a processor chipset (e.g., local to the processor 300). In some other implementations, the memory 304 may reside external to the processor chipset (e.g., remote to the processor 300).

The memory 304 may store computer-readable, computer-executable code including instructions that, when executed by the processor 300, cause the processor 300 to perform various functions described herein. The code may be stored in a non-transitory computer-readable medium such as system memory or another type of memory. The controller 302 and/or the processor 300 may be configured to execute computer-readable instructions stored in the memory 304 to cause the processor 300 to perform various functions. For example, the processor 300 and/or the controller 302 may be coupled with or to the memory 304, the processor 300, and the controller 302, and may be configured to perform various functions described herein. In some examples, the processor 300 may include multiple processors and the memory 304 may include multiple memories. One or more of the multiple processors may be coupled with one or more of the multiple memories, which may, individually or collectively, be configured to perform various functions herein.

The one or more ALUs 306 may be configured to support various operations in accordance with examples as described herein. In some implementations, the one or more ALUs 306 may reside within or on a processor chipset (e.g., the processor 300). In some other implementations, the one or more ALUs 306 may reside external to the processor chipset (e.g., the processor 300). One or more ALUs 306 may perform one or more computations such as addition, subtraction, multiplication, and division on data. For example, one or more ALUs 306 may receive input operands and an operation code, which determines an operation to be executed. One or more ALUs 306 may be configured with a variety of logical and arithmetic circuits, including adders, subtractors, shifters, and logic gates, to process and manipulate the data according to the operation. Additionally, or alternatively, the one or more ALUs 306 may support logical operations such as AND, OR, exclusive-OR (XOR), not-OR (NOR), and not-AND (NAND), enabling the one or more ALUs 306 to handle conditional operations, comparisons, and bitwise operations.

The processor 300 may support wireless communication in accordance with examples as disclosed herein. The processor 300 may be configured to support at least one controller (e.g., the controller 302) coupled with at least one memory (e.g., the memory 304) and configured to or operable to cause the processor to receive uplink resource assignments, where each uplink resource assignment schedules an uplink transmission of a MAC PDU; and determine a priority of the uplink resource assignments for uplink resources that overlap in time based on an LCP that uses priorities of logical channels that have data to be multiplexed in a corresponding MAC PDU.

Additionally, the processor 300 may be configured to or operable to support any one or combination of the at least one controller is operable to cause the processor to determine the priority of an uplink resource assignment based on at least one of a first prioritization part of the LCP or a second prioritization part of the LCP. The at least one controller is operable to cause the processor to receive a configuration of a first priority and a second priority for a LCH; and determine a priority of the LCH for the first prioritization part of the LCP and the second prioritization part of the LCP based on the configuration. The priority of the uplink resource assignment is based on the priorities of the LCHs used for the first prioritization part of the LCP. The priority of the uplink resource assignment is determined based on a first priority that is configured for a LCH. The at least one controller is operable to cause the processor to determine a priority of an uplink grant for a retransmission based on a highest priority of a LCH as determined based on the first prioritization part of the LCP or the second prioritization part of the LCP. The at least one controller is operable to cause the processor to determine a priority of an uplink grant for a retransmission based on a first priority configured for a LCH. The at least one controller is operable to cause the processor to determine a priority of an uplink grant in conjunction with a determination of the priorities of the logical channels based on at least one of a first prioritization part of the LCP or a second prioritization part of the LCP. The at least one controller is operable to cause the processor to determine the priority of the uplink grant based on the first prioritization part of the LCP for generation of the MAC PDU. The at least one controller is operable to cause the processor to determine a priority of a HARQ process based on a priority of a LCH used for a first prioritization part of the LCP or a second prioritization part of the LCP. The at least one controller is operable to cause the processor to determine a priority of a SR based on a priority of a LCH corresponding to the SR.

The processor 300 may support wireless communication in accordance with examples as disclosed herein. The processor 300 may be configured to support at least one controller (e.g., the controller 302) coupled with at least one memory (e.g., the memory 304) and configured to or operable to cause the processor to determine uplink resource assignments, where each uplink resource assignment schedules an uplink transmission of a MAC PDU at a UE; and transmit, to the UE, the uplink resource assignments and an indication of intra-UE prioritization of the uplink resource assignments for uplink resources that overlap in time, the intra-UE prioritization based on an LCP that uses priorities of logical channels that have data to be multiplexed in a corresponding MAC PDU at the UE.

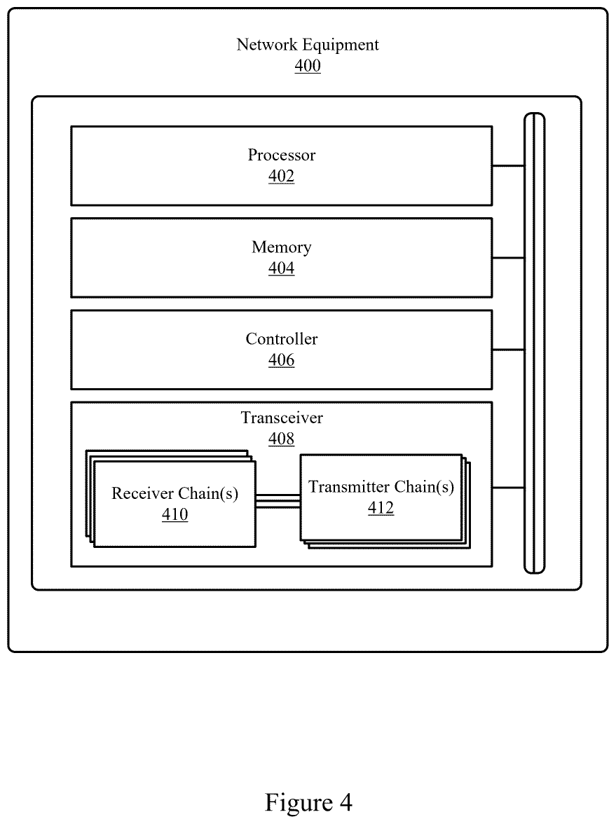

FIG. 4 illustrates an example of a NE 400 in accordance with aspects of the present disclosure. The NE 400 may include a processor 402, a memory 404, a controller 406, and a transceiver 408. The processor 402, the memory 404, the controller 406, or the transceiver 408, or various combinations thereof or various components thereof may be examples of means for performing various aspects of the present disclosure as described herein. These components may be coupled (e.g., operatively, communicatively, functionally, electronically, electrically) via one or more interfaces.

The processor 402, the memory 404, the controller 406, or the transceiver 408, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 402 may include an intelligent hardware device (e.g., a general-purpose processor, a DSP, a CPU, an ASIC, an FPGA, or any combination thereof). In some implementations, the processor 402 may be configured to operate the memory 404. In some other implementations, the memory 404 may be integrated into the processor 402. The processor 402 may be configured to execute computer-readable instructions stored in the memory 404 to cause the NE 400 to perform various functions of the present disclosure.

The memory 404 may include volatile or non-volatile memory. The memory 404 may store computer-readable, computer-executable code including instructions when executed by the processor 402 cause the NE 400 to perform various functions described herein. The code may be stored in a non-transitory computer-readable medium such as the memory 404 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 402 and the memory 404 coupled with the processor 402 may be configured to cause the NE 400 to perform one or more of the functions described herein (e.g., executing, by the processor 402, instructions stored in the memory 404). For example, the processor 402 may support wireless communication at the NE 400 in accordance with examples as disclosed herein. The NE 400 may be configured to or operable to support a means for determining uplink resource assignments, where each uplink resource assignment schedules an uplink transmission of a MAC PDU at a UE; and transmitting, to the UE, the uplink resource assignments and an indication of intra-UE prioritization of the uplink resource assignments for uplink resources that overlap in time, the intra-UE prioritization based on an LCP that uses priorities of logical channels that have data to be multiplexed in a corresponding MAC PDU at the UE.

Additionally, or alternatively, the NE 400 may support at least one memory (e.g., the memory 404) and at least one processor (e.g., the processor 402) coupled with the at least one memory and configured to or operable to cause the NE to determine uplink resource assignments, where each uplink resource assignment schedules an uplink transmission of a MAC PDU at a UE; and transmit, to the UE, the uplink resource assignments and an indication of intra-UE prioritization of the uplink resource assignments for uplink resources that overlap in time, the intra-UE prioritization based on an LCP that uses priorities of logical channels that have data to be multiplexed in a corresponding MAC PDU at the UE.

The controller 406 may manage input and output signals for the NE 400. The controller 406 may also manage peripherals not integrated into the NE 400. In some implementations, the controller 406 may utilize an operating system such as iOS®, ANDROID®, WINDOWS®, or other operating systems. In some implementations, the controller 406 may be implemented as part of the processor 402.

In some implementations, the NE 400 may include at least one transceiver 408. In some other implementations, the NE 400 may have more than one transceiver 408. The transceiver 408 may represent a wireless transceiver. The transceiver 408 may include one or more receiver chains 410, one or more transmitter chains 412, or a combination thereof.

A receiver chain 410 may be configured to receive signals (e.g., control information, data, packets) over a wireless medium. For example, the receiver chain 410 may include one or more antennas to receive a signal over the air or wireless medium. The receiver chain 410 may include at least one amplifier (e.g., a low-noise amplifier (LNA)) configured to amplify the received signal. The receiver chain 410 may include at least one demodulator configured to demodulate the receive signal and obtain the transmitted data by reversing the modulation technique applied during transmission of the signal. The receiver chain 410 may include at least one decoder for decoding the demodulated signal to receive the transmitted data.

A transmitter chain 412 may be configured to generate and transmit signals (e.g., control information, data, packets). The transmitter chain 412 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 412 may also include at least one power amplifier configured to amplify the modulated signal to an appropriate power level suitable for transmission over the wireless medium. The transmitter chain 412 may also include one or more antennas for transmitting the amplified signal into the air or wireless medium.

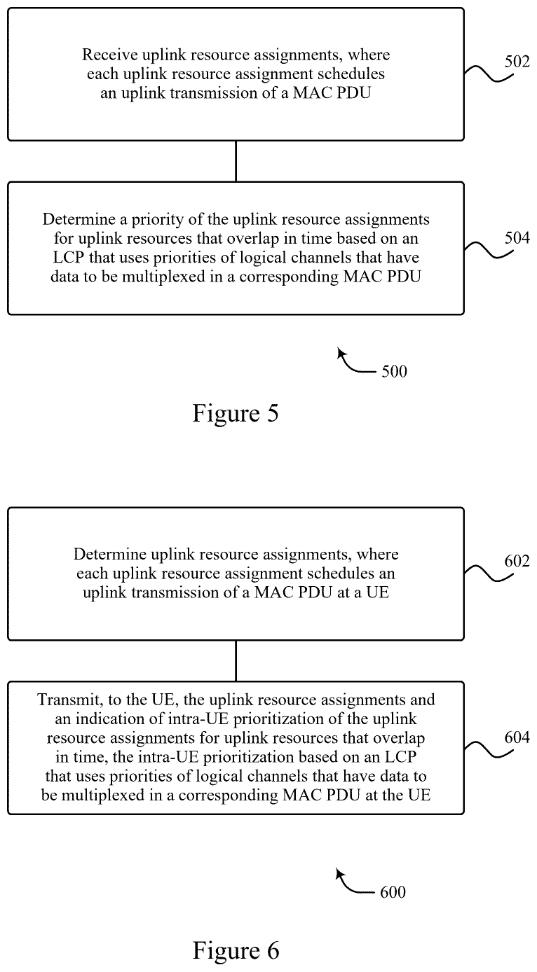

FIG. 5 illustrates a flowchart of a method 500 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 502, the method may include receiving uplink resource assignments, where each uplink resource assignment schedules an uplink transmission of a MAC PDU. The operations of 502 may be performed in accordance with examples as described herein. In some implementations, aspects of the operations of 502 may be performed by a UE as described with reference to FIG. 2.

At 504, the method may include determining a priority of the uplink resource assignments for uplink resources that overlap in time based on an LCP that uses priorities of logical channels that have data to be multiplexed in a corresponding MAC PDU. The operations of 504 may be performed in accordance with examples as described herein. In some implementations, aspects of the operations of 504 may be performed by a UE as described with reference to FIG. 2.

FIG. 6 illustrates a flowchart of a method 600 in accordance with aspects of the present disclosure. The operations of the method may be implemented by a NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 602, the method may include determining uplink resource assignments, where each uplink resource assignment schedules an uplink transmission of a MAC PDU at a UE. The operations of 602 may be performed in accordance with examples as described herein. In some implementations, aspects of the operations of 602 may be performed by a NE as described with reference to FIG. 4.

At 604, the method may include transmitting, to the UE, the uplink resource assignments and an indication of intra-UE prioritization of the uplink resource assignments for uplink resources that overlap in time, the intra-UE prioritization based on an LCP that uses priorities of logical channels that have data to be multiplexed in a corresponding MAC PDU at the UE. The operations of 604 may be performed in accordance with examples as described herein. In some implementations, aspects of the operations of 604 may be performed by a NE as described with reference to FIG. 4.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive uplink resource assignments, wherein each uplink resource assignment schedules an uplink transmission of a medium access control (MAC) protocol data unit (PDU); and
determine a priority of the uplink resource assignments for uplink resources that overlap in time based at least in part on a logical channel prioritization (LCP) that uses priorities of logical channels (LCHs) that are multiplexed or have data to be multiplexed in a corresponding MAC PDU.

2. The UE of claim 1, wherein the at least one processor is operable to cause the UE to determine the priority of an uplink resource assignment based on at least one of a first prioritization part of the LCP or a second prioritization part of the LCP.

3. The UE of claim 1, wherein the at least one processor is operable to cause the UE to:
receive a configuration of a first priority and a second priority for a LCH; and
determine a priority of the LCH for a first prioritization part of the LCP and a second prioritization part of the LCP based at least in part on the configuration.

4. The UE of claim 2, wherein the priority of the uplink resource assignment is determined based at least in part on a highest priority among the priorities of the LCHs that are multiplexed or have data available that can be multiplexed in the corresponding MAC PDU.

5. The UE of claim 2, wherein the priority of the uplink resource assignment is determined based at least in part on a priority of a LCH that is used for the first prioritization part of the LCP.

6. The UE of claim 2, wherein the at least one processor is operable to cause the UE to determine a priority of an uplink grant for a retransmission based on a highest priority among the priorities of the LCHs that are multiplexed.

7. The UE of claim 2, wherein the at least one processor is operable to cause the UE to determine a priority of an uplink grant for a retransmission based on the priorities of the LCHs that are used for the first prioritization part of the LCP.

8. The UE of claim 1, wherein the at least one processor is operable to cause the UE to determine a priority of an uplink grant based on the priorities of the LCHs used for at least one of initial transmission or retransmission as a highest priority that can be applied in a first prioritization part of the LCP.

9. The UE of claim 1, wherein the at least one processor is operable to cause the UE to:
receive a configuration of a first priority and a second priority for a LCH; and
determine a priority of the LCH as a highest priority that can be applied or has been applied to the LCH in the LCP for generation of the corresponding MAC PDU.

10. The UE of claim 1, wherein the at least one processor is operable to cause the UE to determine a priority of a hybrid automatic repeat request (HARQ) process based at least in part on a priority of a logical channel (LCH) used for a first prioritization part of the LCP or a second prioritization part of the LCP.

11. (canceled)

12. A method performed by a user equipment (UE), the method comprising:
receiving uplink resource assignments, wherein each uplink resource assignment schedules an uplink transmission of a medium access control (MAC) protocol data unit (PDU); and
determining a priority of the uplink resource assignments for uplink resources that overlap in time based at least in part on a logical channel prioritization (LCP) that uses priorities of logical channels (LCHs) that are multiplexed or have data to be multiplexed in a corresponding MAC PDU.

13. The method of claim 12, further comprising:
determining the priority of an uplink resource assignment based on at least one of a first prioritization part of the LCP or a second prioritization part of the LCP.

14. The method of claim 12, further comprising:
receiving a configuration of a first priority and a second priority for a LCH; and
determining a priority of the LCH for a first prioritization part of the LCP and a second prioritization part of the LCP based at least in part on the configuration.

15. The method of claim 13, wherein the priority of the uplink resource assignment is determined based at least in part on a highest priority among the priorities of the LCHs that are multiplexed or have data available that can be multiplexed in the corresponding MAC PDU.

16. The method of claim 13, wherein the priority of the uplink resource assignment is determined based at least in part on a priority of a LCH that is used for the first prioritization part of the LCP.

17. The method of claim 13, further comprising:
determining a priority of an uplink grant for a retransmission based on a highest priority among the priorities of the LCHs that are multiplexed.

18. The method of claim 13, further comprising:
determining a priority of an uplink grant for a retransmission based on the priorities of the LCHs that are used for the first prioritization part of the LCP.

19. (canceled)

20. (canceled)

21. The method of claim 12, further comprising:
receiving a configuration of a first priority and a second priority for a LCH; and
determining a priority of the LCH as a highest priority that can be applied or has been applied to the LCH in the LCP for generation of the corresponding MAC PDU.

22. A user equipment (UE) for wireless communication, comprising:
at least one memory; and
at least one processor coupled with the at least one memory and operable to cause the UE to:
receive uplink resource assignments, wherein each uplink resource assignment schedules an uplink transmission of a medium access control (MAC) protocol data unit (PDU); and
determine a priority of a hybrid automatic repeat request (HARQ) process based at least in part on a highest priority among priorities of logical channels (LCHs) that are multiplexed or have data to be multiplexed in a corresponding MAC PDU.

23. A method performed by a user equipment (UE), the method comprising:
receiving uplink resource assignments, wherein each uplink resource assignment schedules an uplink transmission of a medium access control (MAC) protocol data unit (PDU); and
determining a priority of a hybrid automatic repeat request (HARQ) process based at least in part on a highest priority among priorities of logical channels (LCHs) that are multiplexed or have data to be multiplexed in a corresponding MAC PDU.
